(19) United States
(12) Patent Application Publication
(10) Pub. No.: US 2025/0142472 A1
(43) Pub. Date: May 1, 2025

(54) METHOD AND APPARATUS FOR MEASURING NEIGHBORING CELL BY USER EQUIPMENT HAVING WAKE-UP RECEIVER IN WIRELESS COMMUNICATION SYSTEM

(71) Applicant: Samsung Electronics Co., Ltd., Gyeonggi-do (KR)

(72) Inventors: Seunghoon CHOI, Gyeonggi-do (KR); Hyewon YANG, Gyeonggi-do (KR); Jaewon LEE, Gyeonggi-do (KR)

(21) Appl. No.: 18/925,961

(22) Filed: Oct. 24, 2024

(30) Foreign Application Priority Data
Oct. 27, 2023 (KR) 10-2023-0145448

(51) Int. Cl. H04W 52/02; H04W 8/22; H04W 48/20

(52) U.S. Cl. CPC H04W 52/0229; H04W 8/22; H04W 48/20

(57) ABSTRACT

The disclosure relates to a 5G or 6G communication system for supporting a higher data transmission rate. A method performed by a user equipment (UE) in a wireless communication system includes transmitting, to a base station, wake-up signal reception-related UE capability information, receiving, from the base station, wake-up signal reception-related information, and performing measurement on at least one neighbor cell by one of a wake-up receiver of the UE and a main radio of the UE based on the wake-up signal reception-related information.

### CROSS-REFERENCE TO RELATED APPLICATION(S)

This application is based on and claims priority under 35 U.S.C. § 119 to Korean Patent Application No. 10-2023-0145448, which was filed in the Korean Intellectual Property Office on Oct. 27, 2023, the entire disclosure of which is incorporated herein by reference.

### BACKGROUND

### 1. Field

The disclosure relates to a method and apparatus for a UE having a wake-up receiver (WUR) to perform radio resource management (RRM) measurements in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as an LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As described above, as wireless communication systems develop, there is a need in the art for a method for signal transmission by a UE having a WUR, to address excessive UE power consumption and achieve high energy efficiency.

### SUMMARY

The disclosure has been made to address at least the above-mentioned problems and/or disadvantages and to provide at least the advantages described below.

Accordingly, an aspect of the disclosure is to provide a method and device for a UE having a WUR to perform RRM measurements, particularly a neighbor cell, in a wireless communication system.

An aspect of the disclosure is to provide a method and device for cell signal quality measurement and cell selection by a UE having a WUR, to achieve high energy efficiency and address the excessive UE power consumption issue in a wireless communication system.

In accordance with an aspect of the disclosure, a method by a UE in a wireless communication system includes transmitting, to a base station, wake-up signal (WUS) reception-related UE capability information, receiving, from the base station, WUS reception-related information, and performing measurement on at least one neighbor cell by one of the WUR of the UE and a main radio of the UE based on the WUS reception-related information.

In accordance with an aspect of the disclosure, a method performed by a base station in a wireless communication system includes receiving, from a UE, WUS reception-related UE capability information, and transmitting, to the UE, WUS reception-related information, wherein the WUS reception-related information is used to perform measurement on at least one neighbor cell by one of a WUR of the UE and a main radio of the UE.

In accordance with an aspect of the disclosure, a UE in a wireless communication system includes a transceiver, and at least one processor configured to transmit, to a base station, WUS reception-related UE capability information, receive, from the base station, WUS reception-related information, and perform measurement on at least one neighbor cell by one of a WUR of the UE and a main radio of the UE based on the WUS reception-related information.

In accordance with an aspect of the disclosure, a base station in a wireless communication system includes a transceiver, and at least one processor configured to receive, from a UE, WUS reception-related UE capability information, and transmit, to the UE, WUS reception-related information, wherein the WUS reception-related information is used to perform measurement on at least one neighbor cell by one of a WUR of the UE and a main radio of the UE.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency resource region in a wireless communication system according to an embodiment;

FIG. 2 illustrates a time domain mapping structure of a synchronization signal and a beam sweeping operation according to an embodiment;

FIG. 3 illustrates a signal flow for RA according to an embodiment;

FIG. 4 illustrates a signal flow for reporting UE capability information to a base station by a UE according to an embodiment;

FIG. 5 illustrates a state of a UE according to a state of a base station and state switch of the UE and the base station according to an embodiment;

FIG. 6 illustrates a method of RRM measurement of a UE having a WUR according to an embodiment;

FIG. 7 illustrates a method of a base station to transmit a signal for measuring an RRM according to an embodiment;

FIG. 8 illustrates a functional structure of a UE according to an embodiment; and

FIG. 9 illustrates a functional structure of a base station according to an embodiment.

### DETAILED DESCRIPTION

Hereinafter, embodiments of the disclosure are described in detail with reference to the accompanying drawings. The same reference denotations may be used to refer to the same or similar elements throughout the specification and the drawings.

Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Embodiments of the disclosure enable a constitution of the disclosure to be complete and are provided to fully inform the scope of the disclosure to those of ordinary skill in the art to which the disclosure pertains.

The same reference numeral denotes the same element throughout the specification. The components included in the disclosure are represented in singular or plural forms depending on the embodiment. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Herein, terms for identifying access nodes and denoting network entities, messages, inter-network entity interfaces, and various pieces of identification information are provided as an example for ease of description. Thus, the disclosure is not limited to the terms, and the terms may be replaced with other terms denoting objects with equivalent technical meanings.

In the disclosure, the terms physical channel and signal may be used interchangeably with data or control signal. For example, physical downlink shared channel (PDSCH) denotes a physical channel where data is transmitted, but PDSCH may also be used to denote data. In other words, the expression “transmits a physical channel” in the disclosure may be equally interpreted as “transmits data or a signal through the physical channel.”

In the disclosure, higher signaling refers to a signal transfer method that transfers a signal from the base station to the UE using a physical layer downlink data channel or from the UE to the base station using a physical layer uplink data channel. Higher signaling may also be appreciated as radio resource control (RRC) signaling or media access control (MAC) control element (CE).

Although the disclosure describes various embodiments using terms used in some communication standards (e.g., 3rd generation partnership project (3GPP)), this is merely an example for description. The disclosure may be easily modified and applied in other communication systems. The term UE may refer to mobile phones, smartphones, IoT devices, sensors, as well as other wireless communication devices.

Hereinafter, the base station may be an entity allocating resource to terminal and may be at least one of gNode B (gNB), eNode B (eNB), Node B, BS, wireless access unit, base station controller, or node over network. The terminal may include a UE, mobile station (MS), cellular phone, smartphone, computer, or multimedia system capable of performing communication functions. Although LTE, LTE-A, or NR based systems are described as examples in connection with embodiments of the disclosure, various embodiments may also apply to other communication systems with a similar technical background or channel form. Embodiments may be modified in such a range as not to significantly depart from the scope of the disclosure under the determination by one of ordinary skill in the art and such modifications may be applicable to other communication systems.

To process recently soaring mobile data traffic, the initial standards of the 5G system or NR, which is the next-generation communication system after long term evolution (LTE) or evolved universal terrestrial radio access (E-UTRA) and LTE-advanced (LTE-A) or E-UTRA evolution, have been completed. While the conventional mobile communication system focuses on typical voice/data communication, the 5G system aims to meet various services and requirements, such as an eMBB service for enhancing conventional voice/data communication, a URLLC service, and an mMTC service supporting a large amount of things communication.

While the legacy LTE and LTE-A system transmission bandwidth per single carrier is limited to up to 20 MHz, the 5G system mainly aims for high-speed data services ranging from several Gbps by utilizing a much wider ultra-wide bandwidth. Accordingly, 5G systems are considering ultra-high frequency bands ranging from several GHz to up to 100 GHz, in which it is relatively easy to secure ultra-wideband width frequencies, as candidate frequencies. Further, it is possible to secure a broadband frequency for a 5G system by relocating or allocating frequencies among frequency bands included in several GHz from hundreds of megahertz (MHz) used in legacy mobile communication systems.

Radio waves in the ultra-high frequency band are referred to as mm Waves. However, in the ultra-high frequency band, the pathloss of radio waves increases in proportion to the frequency band, and the coverage of the mobile communication system decreases.

To overcome the disadvantage of coverage reduction in the ultra-high frequency band, a beamforming technology is applied to increase the arrival distance of radio waves by concentrating the radiation energy of radio waves to a predetermined target point using a plurality of antennas. In other words, in the signal to which the beamforming technology is applied, the beam width of the signal becomes relatively narrow, and radiation energy is concentrated within the narrowed beam width, thereby increasing the radio wave arrival distance. The beamforming technology may be applied to each of the transmission end and the reception end. In addition to the coverage increase effect, the beamforming technology has an effect of reducing interference in areas other than the beamforming direction. For the beamforming technology to operate properly, an accurate measurement and feedback method for the transmission/reception beam is required. The beamforming technology may be applied to a control channel or a data channel one-to-one corresponding between a predetermined UE and a base station. Beamforming technology for increasing coverage may also be applied to the control channel and data channel for transmitting the common signals transmitted to a plurality of UEs in the system by the base station, e.g., synchronization signal, physical broadcast channel (PBCH), and system information. When the beamforming technology is applied to the common signal, the beam sweeping technology that transmits the signal with the beam direction changed may be additionally applied so that the common signal may reach the UE present at an arbitrary position in the cell.

As another requirement of the 5G system, an ultra-low latency service with a transmission delay of about 1 ms between transmission and reception UEs is required. To reduce transmission delay, there is a need in the art for a short transmission time interval (TTI)-based frame structure that is shorter than in LTE and LTE-A. The TTI is a basic time unit for performing scheduling, and the TTI of the legacy LTE and LTE-A systems is 1 millisecond (ms) corresponding to the length of one subframe. For example, there is a need in the art for a short TTI for meeting the requirements for the ultra-low latency service of the 5G system, 0.5 ms, 0.25 ms, 0.125 ms, etc., which are shorter than legacy LTE and LTE-The systems.

The uplink (UL) may refer to a wireless link in which the UE transmits data or the control signal to the base station, and the downlink (DL) may refer to a wireless link in which the base station transmits data or the control signal to the UE.

When the UE accesses the system for the first time, the UE may synchronize DL time and frequency from a synchronization signal transmitted by the base station through a cell search and obtain a cell identifier (ID). The UE may receive a PBCH using the obtained cell ID and obtain a master information block (MIB) that is essential system information from the PBCH. Additionally, the UE may receive a system information block (SIB) transmitted by the base station to obtain cell-common transmission/reception-related control information. The cell-common transmission/reception-related control information may include random access (RA)-related control information, paging-related control information, common control information for various physical channels, and the like.

The synchronization signal serves as a reference for cell search, and a subcarrier spacing may be applied for each frequency band to be suitable for a channel environment such as phase noise. In the case of the data channel or the control channel, the subcarrier spacing may be adaptively applied according to the service type to support various services as described above.

5G systems have been designed for various uses. In addition to latency, reliability, and availability, energy efficiency of a UE is very important in a 5G system. The 5G UE should charge on a weekly or daily basis according to the user's usage time, and generally consumes tens of mW in the RRC_IDLE/RRC_INACTIVE state and hundreds of mW in the RRC_CONNECTED state. Design for extending battery life may be an essential element for enhancing energy efficiency as well as a better user experience. Energy efficiency may be more important for UEs without continuous energy sources (e.g., UEs using small rechargeable and single coin cell batteries). Among 5G use cases, sensors and actuators are widely arranged for monitoring, measuring, and charging. In general, batteries may not be recharged and may be required to last for at least a few years. Wearables may include smartwatches, rings, eHealth-related devices, and medical monitoring devices, which generally have a battery charge of a maximum of 1-2 weeks between charges depending on usage time.

Power consumption of the 5G UE may depend on a set length (e.g., a paging cycle) of wake-up periods, and an extended discontinuous reception (eDRX) cycle having a large value may be used to meet a battery life requirement. However, the eDRX method is not suitable for services with low waiting time because the battery life is maintained long based on high waiting time. For example, in fire detection and extinguishing use, the fire shutter may be closed within 1 to 2 seconds from the time when the fire is detected by the sensor, and the sprinkler may be turned on by the actuator. In this case, the waiting time may be important, and the long eDRX cycle as conventional is not suitable because the latency requirement may not be met.

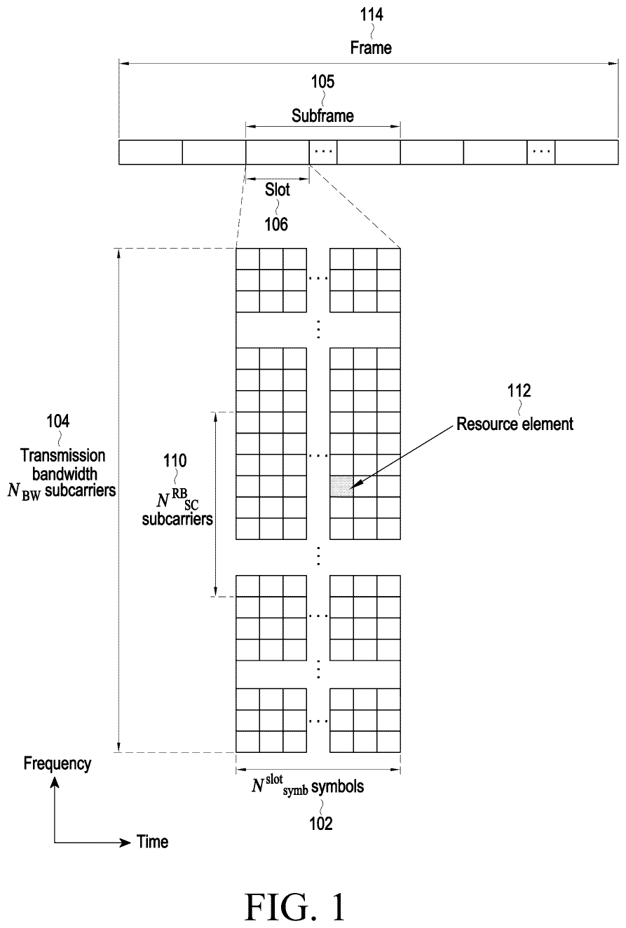

FIG. 1 illustrates a basic structure of a time-frequency resource region in a wireless communication system according to an embodiment.

The time-frequency resource region in FIG. 1 is a radio resource region in which data or control channels are transmitted in a 5G system.

Referring to FIG. 1, the horizontal axis refers to the time domain, and the vertical axis refers to the frequency domain. The minimum transmission unit in the time domain of the wireless communication system is an orthogonal frequency division multiplexing (OFDM) symbol, N_{symb}^{slot} symbols 102 may be gathered to form one slot 106, and Nₛₗₒₜ^{subframe} slot may be gathered to form one subframe 105. The length of the subframe is 1.0 ms, and 10 subframes may be gathered to form a 10 ms frame 114. In the frequency domain, the minimum transmission unit is subcarrier, and the bandwidth of the overall system transmission band may consist of a total of NBW (104) subcarriers.

The basic resource unit in the time-frequency domain is resource element (RE) 112, and this may be represented with an OFDM symbol index and a subcarrier index. A resource block (RB) (or physical resource block (PRB) may be defined as N_{sc}^{RB} contiguous subcarriers 110 in the frequency domain. In the 5G system, N_{sc}^{RB}=12, and the data rate may increase in proportion to the number of RBs scheduled for the UE.

In a wireless communication system, a base station may map data on an RB basis and generally perform scheduling on the RBs that constitute one slot for a given UE. In other words, the basic time unit in which scheduling is performed in the 5G system may be a slot, and the basic frequency unit in which scheduling is performed may be an RB.

The number N_{symb}^{slot} of OFDM symbols is determined according to the length of the cyclic prefix (CP) added to each symbol to prevent interference between symbols. For example, when a normal CP is applied, N_{symb}^{slot}=14, and when an extended CP is applied N_{symb}^{slot}=12. The extended CP is applied to systems where the radio transmission distance is relatively longer than the normal CP, maintaining the orthogonality between symbols. In the normal CP, the ratio between CP length and symbol length is maintained as a constant value, so that the overhead due to the CP may remain constant regardless of subcarrier spacing. In other words, when the subcarrier spacing decreases, the symbol length may increase, and the CP length may also increase accordingly. Conversely, when the subcarrier spacing increases, the symbol length may decrease, and thus the CP length may decrease. The symbol length and the CP length may be inversely proportional to the subcarrier spacing.

In a wireless communication system, various frame structures may be supported by adjusting subcarrier spacing to meet various services and requirements. For example, from the perspective of the operating frequency band, the larger the subcarrier spacing, the more advantageous it is to recovery of phase noise in a high frequency band. From a transmission time perspective, if the subcarrier spacing is large, the symbol length in the time domain is shortened, and as a result, the slot length is shortened, which is advantageous in supporting ultra-low delay services, such as URLLC. From a cell size perspective, the longer the CP length, the larger cells may be supported, so that the smaller the subcarrier spacing, the relatively larger cells may be supported. In mobile communications, cell is a concept that refers to an area covered by one base station.

Subcarrier spacing, CP length, etc. are essential information for OFDM transmission/reception, and seamless transmission/reception is possible only when the base station and UE recognize subcarrier spacing, CP length, etc. as common values.

Table 1 below illustrates the relationship between subcarrier spacing configuration (μ), subcarrier spacing (Δf), and CP length supported by the 5G system.

TABLE 1

| μ | Δf = 2^{μ} · 15 [kHz] | Cyclic prefix |
|---|---|---|
| 0 | 15 | normal |
| 1 | 30 | normal |
| 2 | 60 | Normal, Extended |
| 3 | 120 | normal |
| 4 | 240 | normal |

Table 2 below illustrates the number (N_{symb}^{slot}) of symbols per slot, the number (Nₛₗₒₜ^{frame,μ}) slot of slots per frame, and the number (Nₛₗₒₜ^{subframe,μ}) of slots per subframe, for each subcarrier spacing configuration (μ) in the normal CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 below illustrates the number (N_{symb}^{slot}) of symbols per slot, the number (Nₛₗₒₜ^{frame,μ}) of slots per frame, and the number (Nₛₗₒₜ^{subframe,μ}) of slots per subframe, for each subcarrier spacing configuration (μ) in the extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

At the early stage of introduction of the 5G system, coexistence or dual-mode operation with the legacy LTE and/or LTE-A (hereinafter, LTE/LTE-A) was expected. As a result, the legacy LTE/LTE-A may provide stable system operation to the UE, and the 5G system may provide enhanced services to the UE. Therefore, the frame structure of the 5G system needs to include at least the LTE/LTE-A frame structure or essential parameter set (e.g., subcarrier spacing=15 kHz).

For example, when comparing a frame structure with a subcarrier spacing configuration μ=0 (hereinafter frame structure A) and a frame structure with a subcarrier spacing configuration μ=1 (hereinafter frame structure B), as compared to frame structure A, frame structure B has the subcarrier spacing and RB size increased in double, and the slot length and symbol length decreased in double. In frame structure B, 2 slots may make up 1 subframe, and 20 subframes may make up 1 frame.

When the frame structure of the 5G system is generalized, the subcarrier spacing, the CP length, the slot length, etc., which are essential parameter sets, are allowed to have an integer multiple relationship therebetween for each frame structure, thereby providing high scalability. A subframe having a fixed length of 1 ms may be defined to represent a reference time unit irrelevant to the frame structure.

The frame structure may be applied in response to various scenarios. From a cell size point of view, the longer the CP length, the larger cell may be supported, so that frame structure A may support a cell relatively greater than frame structure B. From an operating frequency band perspective, the larger the subcarrier spacing, the more advantageous it is to recover the phase noise in a high frequency band, so that frame structure B may support a relatively higher operating frequency than frame structure A. From a service point of view, a shorter length of the slot which is the basic time unit of scheduling may be more advantageous to support an ultra-low latency service, such as URLLC, so that frame structure B may be appropriate for the URLLC service as compared with frame structure A.

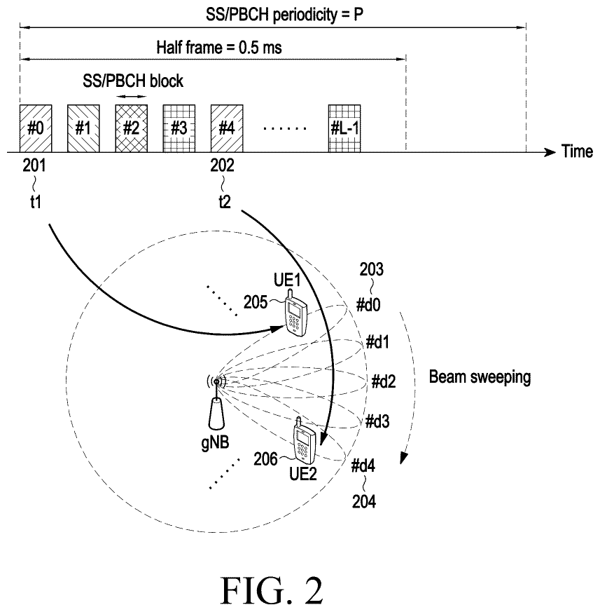

FIG. 2 illustrates a time domain mapping structure of a synchronization signal and a beam sweeping operation.

Hereinafter, for the description of the disclosure, the following components may be previously defined.

Primary synchronization signal (PSS): A signal that serves as a reference for DL time/frequency synchronization and may provide part of the information for cell ID

Secondary synchronization signal (SSS): serves as a reference for DL time/frequency synchronization and may provide remaining partial cell ID information. Additionally, it may serve as a reference signal (RS) for demodulation of PBCH.

The PBCH may provide the MIB, which is essential system information required data channel and control channel transmission/reception by the UE. The essential system information may include search space-related control information indicating radio resource mapping information about a control channel, scheduling control information for a separate data channel for transmitting system information, and information, such as system frame number (SFN), which is the frame unit index serving as a timing reference.

Synchronization signal/PBCH block or SSB (SS/PBCH block): The SS/PBCH block may be constituted of N OFDM symbols and be composed of a combination of the PSS, SSS, and PBCH. In a system to which beam sweeping technology is applied, the SS/PBCH block may be the minimum unit to which beam sweeping is applied. In the 5G system, N=4. The base station may transmit up to L SS/PBCH blocks. The L SS/PBCH blocks may be mapped within a half frame (0.5 ms). The L SS/PBCH blocks may be periodically repeated in units of P, which is a predetermined period. The base station may inform the UE of the period P. If there is no separate signaling for the period P, the UE may apply a previously agreed default value.

FIG. 2 illustrates an example in which beam sweeping applies every SS/PBCH block over time according to an embodiment. Referring to FIG. 2, UE1 205 may receive the SS/PBCH block using the beam radiated in direction #d0 203 by the beamforming applied to SS/PBCH block #0 at time t1 201. UE2 206 may receive the SS/PBCH block using the beam radiated in direction #d4 204 by the beamforming applied to SS/PBCH block #4, at time t2 202. The UE may obtain an optimal synchronization signal through the beam radiated from the base station in the direction where the UE is positioned. For example, it may be difficult for UE1 205 to obtain time/frequency synchronization and essential system information from the SS/PBCH block through the beam radiated in direction #d4 204 away from the position of UE1 205.

In addition to the initial access procedure, the UE may also receive the SS/PBCH block to determine whether the radio link quality of the current cell is maintained at a certain level or higher. Further, in a handover procedure in which the UE moves access from the current cell to the neighboring cell, the UE may determine the radio link quality of the neighboring cell and receive the SS/PBCH block of the neighboring cell to obtain time/frequency synchronization of the neighboring cell.

After the UE obtains MIB and system information from the base station through the initial access procedure, the UE may perform a RA procedure to switch the link with the base station to the connected state (or RRC_CONNECTED state). Upon completing the RA procedure, the UE may switch to the connected state (or RRC_CONNECTED state), and one-to-one communication is possible between the base station and the UE. RA

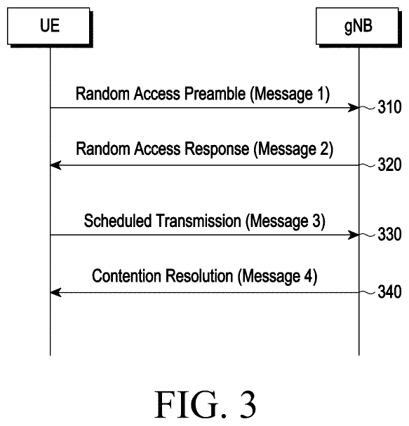

FIG. 3 illustrates a signal flow for RARA according to an embodiment.

Referring to FIG. 3, in step 310, the UE may transmit a RA preamble to the base station. In the RA procedure, the RA preamble, which is the first transmission message of the UE, may be referred to as message 1. The base station may measure a transmission delay value between the UE and the base station from the RA preamble and may synchronize UL. In this case, the UE may arbitrarily select which RA preamble to use within the RA preamble set given by the system information in advance. The initial transmission power of the RA preamble may be determined according to a pathloss between the base station and the UE measured by the UE. The UE may determine the transmission beam direction of the RA preamble from the synchronization signal received from the base station and transmit the RA preamble.

In step 320, the base station may transmit a RA response (RAR) (or message 2) to the RA preamble received in step 310. The base station may transmit an UL transmission timing adjustment command to the UE based on the transmission delay value measured from the RA preamble. The base station may transmit, to the UE, an UL resource and power control command to be used by the UE as scheduling information. The scheduling information transmitted by the base station may include control information about the UL transmission beam of the UE.

When the UE does not receive the RAR (or message 2) which is scheduling information for message 3 from the base station within a predetermined time in step 320, step 310 may be performed again. When step 310 is performed again, the UE may increase the transmission power of the RA preamble by a predetermined step and transmit the increased transmission power (e.g., power ramping), thereby increasing the RA preamble reception probability of the base station.

In step 330, the UE may transmit UL data (i.e., message 3) including its UE ID to the base station using the UL resource allocated in step 320. The UE may transmit UL data including the UE ID to the base station through a physical UL shared channel (PUSCH). The transmission timing of the UL data channel for transmitting message 3 may follow the timing control command received from the base station in step 320. The transmission power of the UL data channel for transmitting message 3 may be determined considering the power control command received from the base station and the power ramping value of the RA preamble in step 320. The UL data channel for transmitting message 3 may refer to the first UL data signal that the UE transmits to the base station after transmitting the RA preamble.

In step 340, when the base station determines that the UE has performed RA without conflicting with another UE, the base station may transmit data (i.e., message 4) including the ID of the UE that has transmitted the UL data in step 330, to the UE. When the signal transmitted by the base station is received from the base station in step 340, the UE may determine that the RA is successful. The UE may transmit hybrid automatic repeat request acknowledgement (HARQ-ACK) information indicating whether message 4 is successfully received to the base station through an UL control channel (PUCCH).

When the data transmitted by the UE in step 330 and the data of another UE collides with each other and the base station fails to receive the data signal from the UE, the base station may no longer transmit the data to the UE. In case that the UE fails to receive data transmitted from the base station in step 340 within a predetermined time, the UE may determine that the RA procedure fails, and may return to step 310.

When the UE successfully completes the RA procedure, the UE may be switched to a connected state (or RRC_CONNECTED state), and one-to-one communication between the base station and the UE may be possible. The base station may receive the UE capability information from the UE in the connected state or RRC_CONNECTED state, and may adjust scheduling by referring to the UE capability information about the corresponding UE. The UE may inform the base station of whether the UE itself supports a predetermined function, the maximum allowable value of the function supported by the UE, and the like through the UE capability information. Accordingly, UE capability information that each UE reports to the base station may be a different value for each UE.

For example, the UE may report UE capability information including at least one of the following control information to the base station.
frequency band related control information supported by terminal
control information related to channel bandwidth supported by UE
control information related to maximum modulation method supported by UE
control information related to maximum beam number supported by terminal
control information related to maximum layer number supported by UE
control information related to CSI reporting supported by UE
control information about whether UE supports frequency hopping
bandwidth-related control information when carrier aggregation (CA) is supported
control information about whether cross carrier scheduling is supported when CA is supported

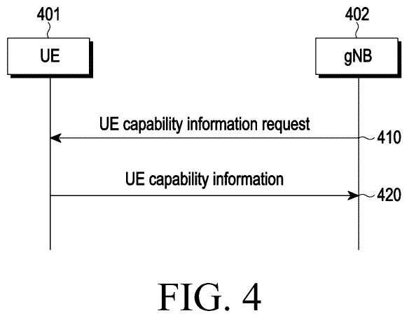

FIG. 4 illustrates a signal flow for reporting UE capability information to a base station by a UE according to an embodiment.

Referring to FIG. 4, in step 410, the base station 402 may transmit a UE capability information request message to the UE 401. Based on the UE capability information request of the base station 402, the UE 401 may transmit UE capability information to the base station in step 420. The UE 401 may transmit UE capability information to the base station 402 regardless of the UE capability information request of the base station 402.

Based on the transmission/reception process of the UE capability information, the UE connected to the base station may perform one-to-one communication with the base station as a UE in the RRC_CONNECTED state. Conversely, the UE that is not connected may be in the RRC_IDLE state, and the UE in the RRC_IDLE state may perform the following process.
perform UE-specific discontinuous reception (DRX) cycle set by higher layer
receive paging message from core network
obtain system information
measurement operation related to serving cell (or cell being camped on) and cell selection/reselection
peripheral cell related measurement operation and cell reselection

The measurement operation related to the serving cell (or the cell being camped on) and the cell selection/reselection, are described in greater detail (which is referred to as main radio (MR) RRM measurement/evaluation in the disclosure). The UE may measure the synchronization signal-reference signal received power (SS-RSRP) and synchronization signal-reference signal received quality (SS-RSRQ) levels for the serving cell (or the cell being camped on) at least every M1*N1 DRX cycle and may evaluate the cell selection determination criterion S based on the measured value. When the SMTC cycle is greater than 20 ms, the DRX cycle is less than or equal to 0.64 s, M1=2, and otherwise, M1=1.

N1 may be determined by Table 4 below.

TABLE 4

| | N1 | | | Nₛₑᵣᵥ [number |
|---|---|---|---|---|
| DRX cycle[s] | FR1 | NE11-1 | NE11-2 | of DRX cycles] |
| 0.32 | 1 | 8 | 12 | M1*N1*4 |
| 0.64 | | 5 | 8 | M1*N1*4 |
| 1.28 | | 4 | 6 | N1*2 |
| 2.56 | | 3 | 5 | N1*2 |

The cell selection determination criterion S may be met when Sᵣₓₗₑᵥ>0, where Sᵣₓₗₑᵥ is calculated in Equation (1) below, corresponding to SS-RSRP and S_{qual}>0, where S_{qual} is calculated in Equation (2) below, corresponding to SS-RSRQ.

$${S}_{rxlev} = {Q}_{rxlevmeas} - ( {Q}_{rxlevmin} + {Q}_{rxlevminoffset} ) - {P}_{compensation} - {Q}_{offsettemp} \qquad ( 1 )$$

$${S}_{qual} = {Q}_{qualmeas} - ( {Q}_{qualmin} + {Q}_{qualminoffset} ) - {Q}_{offsettemp} \qquad ( 2 )$$

In Equations (1) and (2), Qᵣₓₗₑᵥₘₑₐₛ may be the measured SS-RSRP, Q_{qualmeas} may be the measured SS-RSRQ, Qᵣₓₗₑᵥₘᵢₙ may be the magnitude level of the reception signal required by the serving cell to the minimum limit and may be received by the UE as system information, and Q_{qualmin} may be the quality level of the reception signal required by the serving cell to the minimum limit and may be received by the UE as system information. The remaining parameters are presented in 3GPP TS 38.304. In determining the measured SS-RSRP, the UE may determine the SS-RSRP of the serving cell by filtering from at least two measurement values separated by at least half of the DRX cycle. In determining the measured SS-RSRQ, the UE may determine the SS-RSRQ of the serving cell by filtering from at least two measurement values separated by at least half of the DRX cycle.

The neighbor cell related measurement operation and cell reselection are described in greater detail. If the UE determines that the serving cell does not meet the cell selection determination criterion S during Nₛₑᵣᵥ consecutive DRX cycles, the UE may start measuring all neighboring cells other than the serving cell. If the UE does not find a new suitable cell for 10s, the UE may initiate a cell selection procedure for the selected public land mobile network (PLMN).

The UE, after initiating measurement of the neighbor cells, may measure the SS-RSRP and SS-RSRQ levels every Tₘₑₐₛᵤᵣₑ and evaluate whether the neighbor cells meet the cell reselection determination criteria within each Tₑᵥₐₗᵤₗₐₜₑ. For newly detected cells, it may be evaluated whether the cell reselection determination criteria are met within each T detect. When the neighbor cell is better than the serving cell according to the cell reselection determination criteria during T_{reselection} and, simultaneously, one or more seconds elapse after the UE camps on the current serving cell, the UE may reselect the neighbor cell as a new serving cell. The parameters such as Tₘₑₐₛᵤᵣₑ, Tₑᵥₐₗᵤₐₜₑ, and T_{reselection} may be determined in the specifications according to the DRX cycle or may be set by the higher signal. In determining the measured SS-RSRP, the UE may determine the SS-RSRP of the neighbor cell by filtering from at least two measurement values separated by at least half of Tₘₑₐₛᵤᵣₑ.

The cell reselection determination criteria may determine cell selection rankings based on Rₛ and Rₙ calculated by the following parameters. In other words, cell rankings may be determined in order of highest values of Rₛ as in Equation (3) below, and Rₙ as in Equation (4) below.

$${R}_{s} = {Q}_{meas , s} + {Q}_{hyst} - {Qoffset}_{temp} \qquad ( 3 )$$

$${R}_{n} = {Q}_{meas , n} - Qoffset - {Qoffset}_{temp} \qquad ( 4 )$$

In Equations (3) and (4), Q_{meas,s} and Q_{meas,n} refer to the RSRP measurements of the serving cell and the neighbor cell, respectively, and Q_{hyst}, Qoffset, and Qoffsetₜₑₘₚ may be set by the higher signal.

When a specific condition is met in relation to neighbor cell measurement, it is possible to stop neighbor cell measurement or to perform neighbor cell measurement by a longer period than Tₘₑₐₛᵤᵣₑ. In an embodiment, when the UE moves at low speed or stops in the cell or when the UE is determined not to be located at the cell boundary, the UE may perform neighbor cell measurement in a period that is longer by the product of Tₘₑₐₛᵤᵣₑ and a scaling factor or may stop neighbor cell measurement for up to one hour.

In the 5G system, a UE in a new state called RRC_INACTIVE has been defined to reduce energy and time consumed for initial access of the UE. The RRC_INACTIVE UE may perform the following process in addition to the operations performed by the RRC_IDLE UE.
save access stratum (AS) information required for cell access
UE-specific DRX cycle operation set by RRC layer
set up a radio access network (RAN)-based notification area (RNA) that may be utilized during handover by the RRC layer and perform periodic updates
monitor RAN-based paging message transmitted through an active-radio network temporary identifier (I-RNTI)

The UE in the RRC_CONNECTED state may be changed from the RRC_CONNECTED state to the RRC_INACTIVE state or the RRC_IDLE state by receiving the RRC release indication from the base station.

The UE in the RRC_INACITVE or RRC_IDLE state may perform RA to complete all RA procedures to change from RRC_INACTIVE or RRC_IDLE to RRC_CONNECTED.

Hereinafter, a scheduling method in which the base station transmits DL data to a UE or instructs the UE to transmit UL data is described.

The DL control information (DCI) may be control information transmitted by the base station to the UE through the DL. The DL control information may include DL data scheduling information or UL data scheduling information for a predetermined UE. In general, the base station may independently perform channel coding for DCI for each UE and then transmit the DCI to each UE through a PDCCH, which is a DL physical control channel.

The base station may apply, to the UE to be scheduled, a DCI format determined according to the purpose such as whether it is scheduling information (DL assignment) for DL data, whether it is scheduling information (UL grant) for UL data, or whether it is DCI for power control.

The base station may transmit DL data to the UE through a PDSCH, which is a physical channel for DL data transmission. The base station may inform the UE of scheduling information such as a specific mapping position in the time and frequency domain of the PDSCH, a modulation scheme, HARQ-related control information, and power control information through the DCI related to DL data scheduling information among DCIs transmitted through the PDCCH.

The UE may transmit UL data to the base station through a PUSCH, which is a physical channel for UL data transmission. The base station may inform the UE of scheduling information such as a specific mapping position in the time and frequency domain of the PUSCH, modulation scheme, HARQ-related control information, power control information, etc. through the DCI related to UL data scheduling information among DCIs transmitted through the PDCCH.

The time-frequency resource to which the PDCCH is mapped may be referred to as a control resource set (CORESET). The CORESET may be configured in all or some frequency resources of a bandwidth supported by the UE in the frequency domain. In the time domain, one or more OFDM symbols may be set, which may be defined as a control resource set duration (CORESET) length. The base station may configure one or more CORESETs for the UE through higher layer signaling information (e.g., system information, MIB, RRC signaling, etc.). “The base station configures the CORESET to the UE” may mean that the base station provides the UE with information such as a CORESET ID, a frequency position of the CORESET, and a symbol length of the CORESET. The information provided by the base station to the UE to configure the CORESET may include at least some of the information included in Table 5 below.

TABLE 5

| | |
|---|---|
| ControlResourceSet ::= | SEQUENCE { |
| controlResourceSetId | ControlResourceSetId, |

(CORESET identity)

| | |
|---|---|
| frequencyDomainResources | BIT STRING (SIZE (45)), |

(frequency domain resources)

| | |
|---|---|
| duration | INTEGER (1..maxCoReSetDuration), |

(CORESET duration)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundling size)

| | |
|---|---|
| interleaverSize | ENUMERATED {n2, n3, n6}, |

```
            (interleaver size)
            shiftIndex
```

| | |
|---|---|
| INTEGER(0..maxNrofPhysicalResourceBlocks-1) | OPTIONAL -- Need S |

```
            (interleaver shift)
        },
```

| | |
|---|---|
| nonInterleaved | NULL |

},

| | |
|---|---|
| precoderGranularity | ENUMERATED {sameAsREG-bundle, |

allContiguousRBs},
(precoding unit)

| | | |
|---|---|---|
| tci-StatesPDCCH-ToAddList | SEQUENCE(SIZE | (1..maxNrofTCI- |

StatesPDCCH)) OF TCI-StateId OPTIONAL, -- Cond NotSIB1-initialBWP
(QCL configuration information)

| | | |
|---|---|---|
| tci-StatesPDCCH-ToReleaseList | SEQUENCE(SIZE | (1..maxNrofTCI- |

StatesPDCCH)) OF TCI-StateId OPTIONAL, -- Cond NotSIB1-initialBWP
(QCL configuration information)

| | |
|---|---|
| tci-PresentInDCI | ENUMERATED {enabled} |

OPTIONAL, -- Need S
(QCL indicator configuration information in DCI)

| | |
|---|---|
| pdcch-DMRS-ScramblingID | INTEGER (0..65535) |

```
OPTIONAL, -- Need S
      (PDCCH DMRS scrambling identity)
  }
```

The CORESET may be constituted of N_{RR}^{CORESET} RBs in the frequency domain, and be constituted of N_{symb}^{CORESET}∈{1,2,3} in the time domain. The NR PDCCH may be constituted of one or more control channel elements (CCEs). One CCE may consist of 6 resource element groups (REGs), and the REG may be defined as 1 RB during 1 OFDM symbol. In one CORESET, REGs may be indexed in a time-first order, starting with REG index 0 from the first OFDM symbol of the CORESET, the lowest RB.

An interleaved scheme and a non-interleaved scheme may be supported as transmission schemes for the PDCCH. The base station may configure the UE with whether to perform interleaving transmission or non-interleaving transmission for each CORESET, through higher layer signaling. Interleaving may be performed in each REG bundle unit. A REG bundle may be defined as a set of one or multiple REGs. The UE may determine a CCE-to-REG mapping scheme in the corresponding CORESET, as shown in Table 6 below, based on whether to perform interleaving or non-interleaving transmission, configured by the base station.

TABLE 6
The CCE-to-REG mapping for a control-resource set can be interleaved or non-interleaved and
is described by REG bundles:

| | |
|---|---|
| - | REG bundle i is defined as REGs {iL, iL + 1, ... , iL + L − 1} where L is the REG |
| | bundle size, i = 0,1, ... , N_{REG}^{CORESET} /L − 1, and N_{REG}^{CORESET} = N_{RB}^{CORESET} N_{symb}^{CORESET} is the |
| | number of REGs in the CORESET |
| - | CCE j consists of REG bundles {f(6j/L),f(6j/L + 1),...,f(6j/L + 6/L − 1)} |
| | where f(•)is an interleaver |

For non-interleaved CCE-to-REG mapping, L = 6 and f (x) = x.
For interleaved CCE-to-REG mapping, L ∈ {2,6}for N_{symb}^{CORESET} = 1 and L ∈ {N_{symb}^{CORESET}, 6}
for N_{symb}^{CORESET} ∈ {2,3}. The interleaver is defined by

```
    f(x) = (rC + c + n_{shift}) mod (N_{REG}^{CORESET} /L)
          x = cR + r
        r = 0,1, ..., R − 1
        c = 0,1, ..., C − 1
      C = N_{REG}^{CORESET} /(LR)
  where R ∈ {2,3,6}.
```

The base station may provide configuration information, such as information regarding the symbols where the PDCCH is mapped in the slot and transmission period, to the UE through signaling.

The search space of the PDCCH is described below. The number of CCEs necessary to transmit a PDCCH may be, e.g., 1, 2, 4, 8, or 16 depending on the aggregation level (AL), and different numbers of CCEs may be used for link adaptation of DL control channel. For example, if AL=L, one DL control channel may be transmitted via L CCEs. The UE performs blind decoding to detect a signal while being unaware of information for DL control channel and, to that end, a search space may be defined which indicates a set of CCEs. The search space is a set of candidate control channels constituted of CCEs that the UE needs to attempt to decode on the given aggregation level, and since there are several aggregation levels to bundle up 1, 2, 4, 8, or 16 CCEs, the UE has a plurality of search spaces. A search space set may be defined as a set of search spaces at all set aggregation levels.

The search spaces may be classified into a common search space (CSS) and a UE-specific search space (USS). A predetermined group of UEs or all the UEs may investigate the common search space of the PDCCH to receive cell-common control information, e.g., paging message, or dynamic scheduling for an SIB. For example, the UE may receive scheduling allocation information about PDSCH for system information reception by examining the CSS of PDCCH. In the CSS, since a certain group of UEs or all the UEs need receive the PDCCH, it may be defined as a set of CCEs previously agreed on. The UE may receive scheduling allocation information for the UE-specific PDSCH or PUSCH by inspecting the USS of the PDCCH. The UE-specific search space may be UE-specifically defined with a function of various system parameters and the ID of the UE.

The base station may configure, to the UE, configuration information for the search space of the PDCCH using higher layer signaling (e.g., SIB, MIB, or RRC signaling). For example, the base station may configure the UE with, e.g., the number of PDCCH candidates at each aggregation level L, monitoring period for search space, monitoring occasion of symbol unit in slot for search space, search space type (CSS or USS), combination of RNTI and DCI format to be monitored in the search space, and CORESET index to be monitored in the search space. For example, parameters for the search space for the PDCCH may include information as shown in Table 7 below.

TABLE 7

| | |
|---|---|
| SearchSpace ::= | SEQUENCE { |
| searchSpaceId | SearchSpaceId, |

(search space identity)

| | |
|---|---|
| controlResourceSetId | ControlResourceSetId |

```
OPTIONAL, -- Cond SetupOnly
      (CORESET identity)
    monitoringSlotPeriodicityAndOffset CHOICE {
      (monitoring slot level period and offset)
```

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

}
OPTIONAL, -- Cond Setup

| | |
|---|---|
| duration | INTEGER (2..2559) |

OPTIONAL, -- Need R
(monitoring length)

| | |
|---|---|
| monitoringSymbolsWithinSlot | BIT STRING (SIZE (14)) |

OPTIONAL, -- Cond Setup
(monitoring symbol position in slot)

| | |
|---|---|
| nrofCandidates | SEQUENCE { |

(number of PDCCH candidates per aggregation level)

| | |
|---|---|
| aggregationLevel1 | ENUMERATED {n0, n1, n2, n3, n4, |

n5, n6, n8},

| | |
|---|---|
| aggregationLevel2 | ENUMERATED {n0, n1, n2, n3, n4, |

n5, n6, n8},

| | |
|---|---|
| aggregationLevel4 | ENUMERATED {n0, n1, n2, n3, n4, |

n5, n6, n8},

| | |
|---|---|
| aggregationLevel8 | ENUMERATED {n0, n1, n2, n3, n4, |

n5, n6, n8},

| | |
|---|---|
| aggregationLevel16 | ENUMERATED {n0, n1, n2, n3, n4, |

n5, n6, n8}
}
OPTIONAL, -- Cond Setup

| | |
|---|---|
| searchSpaceType | CHOICE { |

(search space type)

| | |
|---|---|
| common | SEQUENCE { |

(common search space)

| | |
|---|---|
| dci-Format0-0-AndFormat1-0 | SEQUENCE { |

```
            ...
          }
OPTIONAL, -- Need R
```

| | |
|---|---|
| dci-Format2-0 | SEQUENCE { |
| nrofCandidates-SFI | SEQUENCE { |
| aggregationLevel1 | ENUMERATED {n1, |

n2} OPTIONAL, -- Need R

| | |
|---|---|
| aggregationLevel2 | ENUMERATED {n1, |

n2} OPTIONAL, -- Need R

| | |
|---|---|
| aggregationLevel4 | ENUMERATED {n1, |

n2} OPTIONAL, -- Need R

| | |
|---|---|
| aggregationLevel8 | ENUMERATED {n1, |

n2} OPTIONAL, -- Need R

| | |
|---|---|
| aggregationLevel16 | ENUMERATED {n1, |

```
n2} OPTIONAL -- Need R
            },
            ...
          }
OPTIONAL, -- Need R
```

| | |
|---|---|
| dci-Format2-1 | SEQUENCE { |

```
            ...
          }
OPTIONAL, -- Need R
```

| | |
|---|---|
| dci-Format2-2 | SEQUENCE { |

```
            ...
          }
OPTIONAL, -- Need R
```

| | |
|---|---|
| dci-Format2-3 | SEQUENCE { |
| dummy1 | ENUMERATED {sl1, |

sl2, sl4, sl5, sl8, sl10, sl16, sl20} OPTIONAL, -- Cond Setup

| | |
|---|---|
| dummy2 | ENUMERATED {n1, |

```
n2},
            ...
          }
OPTIONAL -- Need R
        },
```

| | |
|---|---|
| ue-Specific | SEQUENCE { |

(UE-specific search space)

| | |
|---|---|
| dci-Formats | ENUMERATED |

```
{formats0-0-And-1-0, formats0-1-And-1-1},
          ...,
        }
    }
OPTIONAL -- Cond Setup2
  }
```

According to the configuration information transmitted to the UE, the base station may configure one or more search space sets to the UE. The base station may configure search space set 1 and search space set 2 to the UE. Search space set 1 may be configured so that the UE monitors DCI format A, scrambled with X-RNTI, in the CSS, and search space set 2 may be configured so that the UE monitors DCI format B, scrambled with Y-RNTI, in the UE-specific search space.

According to the configuration information transmitted from the base station, one or more search space sets may exist in the CSS or the terminal-specific search space. For example, search space set #1 and search space set #2 may be configured in the CSS, and search space set #3 and search space set #4 may be configured in the UE-specific search space.

In the CSS, the UE may monitor combinations of DCI formats and RNTIs as follows, but the disclosure is not limited thereto.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2 3 with CRC scrambled by TPC-SRS-RNTI

In the UE-specific search space, the UE may monitor combinations of DCI formats and RNTIs as follows, but the disclosure is not limited thereto.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The RNTIs may be defined and used as follows. Of course, various embodiments are not limited to the following examples.
Cell RNTI (C-RNTI): for scheduling UE-specific PDSCH or PUSCH
Temporary cell RNTI (TC-RNTI): for scheduling UE-specific PDSCH
Configured scheduling RNTI (CS-RNTI): for scheduling semi-statically configured UE-specific PDSCH
RARA-RNTI: for scheduling PDSCH in the RA phase
Paging RNTI (P-RNTI): for scheduling PDSCH where paging is transmitted
System information RNTI (SI-RNTI): for scheduling PDSCH where system information is transmitted
Interruption RNTI (INT-RNTI): for indicating whether to puncture PDSCH
Transmit power control for PUSCH RNTI (TPC-PUSCH-RNTI): for indicating power control command for PUSCH
Transmit power control for PUCCH RNTI (TPC-PUCCH-RNTI): for indicating power control command for PUCCH
Transmit power control for SRS RNTI (TPC-SRS-RNTI): for indicating power control command for SRS

The above-described DCI formats may follow the definitions in Table 8 below.

TABLE 8

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no transmission |
| | is intended for the UE |
| 2_2 | Transmission of TPC commands for PUCCH and PUSCH |
| 2_3 | Transmission of a group of TPC commands for SRS |
| | transmissions by one or more UEs |

The search space of the aggregation level L in CORESET p and the search space set s may be expressed by Equation (5) below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + i \qquad ( 5 )$$

In Equation (5),
L: aggregation level
nCI: carrier index
NCCE,p: the total number of CCEs present in control resource set p
nμs,f: slot index
M(L)p,s,max: number of PDCCH candidates of aggregation level L
msnCI=0, . . . , M(L)p,s,max−1: PDCCH candidate index of aggregation level L
i=0, . . . , L−1

The

$${Y}_{p , {n}_{s , f}^{μ}}$$

value is calculated in Equation (6) as follows.

$$- {Y}_{p , {n}_{s , f}^{μ}} = ( {A}_{p} \cdot {Y}_{p , {n}_{s , f}^{μ} - 1} ) mod D \qquad ( 6 )$$

In Equation (6), Yₚ₋₁=n_{RNTI}≠0, A₀=39827, A₁=39829, A₂=39839, D=65537
n_{RNTI}: UE ID

$${Y}_{p , {n}_{s , f}^{μ}}$$

may be 0 in the CSS.

In the UE-specific search space,

$${Y}_{p , {n}_{s , f}^{μ}}$$

may be a value that changes depending on the UE's ID (C-RNTI or ID configured in the UE by the base station) and the time index.

As described above, to achieve a high-speed data service ranging from several Gbps in a 5G system, signal transmission/reception with an ultra-wide bandwidth of tens to hundreds of MHz or several GHz may be supported. Ultra-wideband signal transmission/reception may be supported through a single component carrier (CC), or may be supported through CA technology that combines multiple component carriers. When a mobile communication operator fails to secure a frequency of a bandwidth sufficient to provide a high-speed data service as a single component carrier, the CA technology may increase the sum of frequency bandwidths by combining each component carrier having a relatively small bandwidth and consequently enable a high-speed data service.

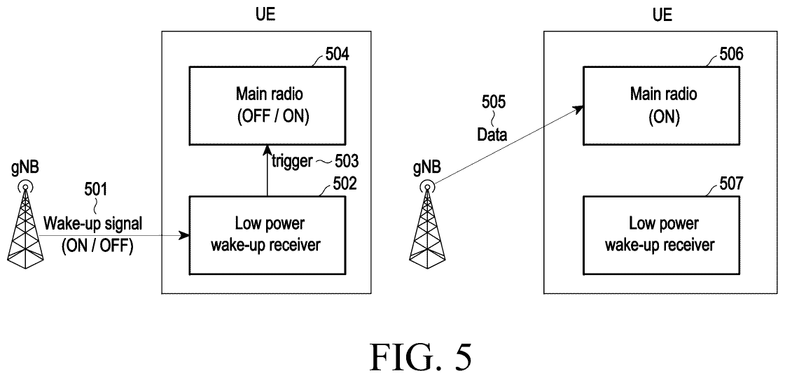

FIG. 5 illustrates a state of a UE according to a state of a base station and state switch of the UE and the base station according to an embodiment.

The 5G UE may need to periodically wake up once per eDRX cycle, which may control power consumption during a period in which there is no signaling or data traffic. If the UE may wake up only when triggered, such as paging, power consumption may be drastically reduced. Drastic power consumption reduction may be achieved by triggering a MR (e.g., conventional NR radio) using a WUS as shown in FIG. 5, and using a WUR, which is a separate receiver capable of monitoring the WUS with ultra-low power, to turn on the MR only when data transmission/reception is required.

Referring to FIG. 5, in step 501, the base station may transmit a WUS corresponding to ON or OFF to the UE.

In step 502, the UE may receive the WUS using the WUR.

In step 503, the UE may trigger the MR in the OFF or ON state based on the received information indicating that the received signal corresponds to ON or OFF.

In step 504, the UE may wake up the MR or power off. According to an embodiment, it may be set to a deep sleep (DS) state or an ultra-deep sleep (UDS) state rather than a completely OFF state.

In step 505, when data traffic to be transmitted from the base station to the UE occurs and the WUS transmitted from the base station in step 501 is a signal corresponding to ON, in step 506, the MR may be ON, and the UE may receive the data transmitted from the base station through the MR rather than through the WUR 507.

Since the power consumption for monitoring the WUS depends on the hardware module of the WUR used for designing the WUS, detecting and processing signals, the gain may be maximized for IoT use cases (such as industrial sensors and controllers) and devices that are sensitive to power and have a small form factor.

The UE including the WUR may report to the base station that the UE has the capability to wake up the MR using the WUR or may report to the base station capability information indicating that the UE includes the WUR.

The UE may report capability information about the WUR to the base station through the UE capability information reporting procedure of FIG. 4.

The UE may report, to the base station, capability information about the WUR through at least one step of the RA preamble or UL data channel in the RA procedure of FIG. 3. According to an embodiment, sets of RA preambles that may be transmitted by the UE including the WUR may be transmitted to the UE through system information. The UE may select a RA preamble within the set received by the UE, and may transmit the RA preamble in step 310 of the RA procedure of FIG. 3 based on the selected RA preamble. According to an embodiment, after reporting capability information about the WUR to the base station, the UE may receive information indicating whether to use the WUR from the base station through the higher layer signaling information or physical signal.

When the base station supports the UE including the WUR (e.g., when the base station includes hardware capable of transmitting the WUS), the base station may determine whether to use the WUR after receiving capability information about the WUR from the UE. The base station may transmit, to the UE, a signal indicating whether to use the WUR or configuration information for receiving the WUS. The base station may transmit, to the UE, at least one of indication information indicating that the UE receives the WUS or activates the WUR or indication information indicating that the base station transmits the WUS. A slot configured by the base station (or defined in the standard) after the slot in which the signal is received, the UE may turn off the MR and may turn on the WUR for monitoring the WUS. The UE may transmit, to the base station, at least one of feedback indicating that the signal indicating whether to use the WUR is received before the MR is turned off or feedback indicating that the MR is turned off and the WUR is turned on.

When the base station does not support the UE including the WUR, the base station may receive capability information about the WUR from the UE and then transmit a signal indicating that the WUR may not be used to the UE. In this case, the UE may transmit, to the base station, feedback indicating that a signal indicating that the WUR may not be used is received. The UE may perform an operation based on parameters of the conventional power saving method set by the base station using the conventional power saving method (C-DRX or I-DRX such as paging).

After reporting the capability of the UE including the WUR and whether to support (or permit) the WUR from the base station, the WUR of the UE may perform an operation of turning on and off the MR of the UE by receiving the WUS. The UE may perform operation procedures of turning on/off the MR, an operation of reporting the capability of the UE having the WUR, or procedures of receiving information about whether to support the WUR from the base station. For example, even when the capability reporting operation of the UE and the authorization procedure are not performed by the base station, the base station may transmit a signal indicating whether to use the WUR or configuration information for receiving the WUS to the UE. Accordingly, the UE including the WUR among the UEs receiving the signal from the base station may turn on/off the MR through the WUR.

The operation of performing the on/off of the MR through the wakeup receiver after the UE capability reporting operation and the base station authorization procedure may be applied to all of the UEs (e.g., an RRC_CONNECTED UE, an RRC_IDLE/RRC_INACTIVE UE, or a UE (e.g., an RRC_CONNECTED UE) accessing the cell in the cell supported by the base station. When the capability reporting operation of the UE and the base station permitting procedure are not performed, the operation of turning on/off the MR through the WUR may be applied to the RRC_IDLE/RRC_INACTIVE UE camping on in the cell supported by the base station. Embodiments may include at least one of all, some, or combinations of some of, various operations of a UE including a WUR and a base station described below.

Hereinafter, the operation of turning on and off the MR of the UE including the WUR is described.

When the MR of the UE is on, the UE may receive a DL signal (or data) from the base station through the MR. When the MR is “on”, the MR may be expressed as “on” or “active” but, without limitations thereto, may be represented as similar or substantially equivalent thereto in meaning. When the MR is activated, it may mean that specific components (e.g., radio frequency (RF) or baseband (BB)) of the MR are on or active or may be defined by the relevant standard. However, The disclosure is not limited to the above description, and when the MR is activated, it may mean parameters equivalent or substantially similar in meaning thereto or performing operations based on the parameters.

Alternatively, the MR may perform an operation of receiving a specific channel or signal (e.g., an SS/PBCH block including a synchronization signal or a PDCCH including a down-control channel) defined in the relevant standard.

When the MR of the UE is off, the UE may be considered to be in a sleep period or may not receive a DL signal (or data) from the base station. When the MR is “off”, the MR may be expressed as “off” or “inactive”, but without limitations thereto, may be represented as similar or substantially equivalent thereto in meaning. When the MR is deactivated, the RF or BB of the MR are off or inactive or may be defined by the relevant standard. However, the disclosure is not limited to the above description, such that when the MR is deactivated, parameters equivalent or substantially similar in meaning thereto or performing operations based on the parameters may exist. Alternatively, the MR may no longer perform an operation of receiving a specific channel or signal defined in the relevant standard.

As described above, to reduce power consumption, the UE may trigger the MR on through the WUR and allow the MR to receive DL signals from the base station only when the UE receives the WUS from the base station and, when receiving no WUS, turn off the MR. In this case, the UE in the RRC IDLE or RRC INACTIVE state may still be required to perform serving cell (or camped-on cell) related measurement and neighbor cell related measurement operation and cell selection/reselection evaluation. In this case, when the neighbor cell measurement initiation condition, other than the serving cell, is met so that the MR is triggered every DRX cycle to perform neighbor cell measurement and evaluation, a significant amount may be lost from the power savings that may be obtained by using the WUR, due to the power required during the process in which sync and adaptive gain control (AGC) should be performed to be able to normally discover the DL control channel in the on state and transition energy from off to on of the MR. The disclosure describes a method for addressing such issues.

Herein, operations or procedures described as being performed by the MR or the WUR for the UE including the WUR (i.e., the UE having the capability to receive a wake-up) may also be performed by the UE including the WUR (i.e., the UE having the capability to receive a wake-up).

When the WUR is on to be configured or activated to be able to discover a WUS, and the MR is off, the WUR of the UE (or a UE having a WUR) may perform RRM measurement/evaluation instead of the conventional RRM measurement/evaluation that is performed by the MR of the UE. As such, the RRM measurement/evaluation that is performed by the WUR of the UE is referred to as lower power WUR (LR-WUR) (LR) RRM measurement/evaluation.

When the MR is turned off every DRX cycle when MR RRM measurement/evaluation should be performed, LR RRM measurement/evaluation may be performed instead. Alternatively, a cycle for LR RRM measurement/evaluation may be separately defined in the standard. When the WUR of the UE performs LR RRM measurement, the measured signal may be one of the PSS, SSS, and PBCH included in the existing SS/PBCH block, and may be a dedicated sync signal of the WUR or a WUS.

When the WUR of the UE (or a UE having a WUR) performs LR RRM measurement/evaluation, a separate set of parameters required when performing MR RRM measurement/evaluation may be defined to perform LR RRM measurement/evaluation as an embodiment for determining the cell selection determination criteria. For example, that the cell selection determination criteria S may be met when Sᵣₓₗₑᵥ>0 corresponding to SS-RSRP, where Sᵣₓₗₑᵥ is calculated in Equation (7) below, and S_{qual}>0 corresponding to SS-RSRQ, where S_{qual} is calculated in Equation (8) below, is the same as that of MR RRM measurement/evaluation, but the following parameters in determining Sᵣₓₗₑᵥ and S_{qual} are for a WUR, and the parameters may be separately defined in the standard or may be received, as system information, by the UE during configuration for WUS reception.

$${S}_{rxlev} = {Q}_{rxlevmeas} - ( {Q}_{rxlevmin} + {Q}_{rxlevminoffset} ) - {P}_{compensation} - {Q}_{offsettemp} \qquad ( 7 )$$

$${S}_{qual} = {Q}_{qualmeas} - ( {Q}_{qualmin} + {Q}_{qualminoffset} ) - {Q}_{offsettemp} \qquad ( 8 )$$

When the WUR of the UE (or a UE having a WUR) performs LR RRM measurement/evaluation, a new parameter for performing LR RRM measurement/evaluation may be added to the cell selection determination criteria as another embodiment for determining the cell selection determination criteria. For example, that the cell selection determination criteria S may be met when Sᵣₓₗₑᵥ>0 corresponding to SS-RSRP and S_{qual}>0 corresponding to SS-RSRQ is the same as that of MR RRM measurement/evaluation, but it may be added as a new parameter (Q_{LP_SS} or Q_{sensitivity}) in the equation for determining Sᵣₓₗₑᵥ and S_{qual} so that the addition in the equation may be explicitly shown or may be added to the existing parameters (Qᵣₓₗₑᵥₘᵢₙ or Q_{qualmin}) so that it is not directly shown in the equation, but applies only when LR RRM measurement/evaluation is performed. The new parameter may be a value Q_{LP_SS} for compensating for the difference in reception magnitude or reception quality between the WUR dedicated sync signal and the existing SS/PBCH block or may be a value Q_{sensitivity} for compensating for the difference in sensitivity between the hardware of the WUR and the hardware of the MR. These values may be defined separately in the standard or may be received by the UE as system information when setting up to receive a WUS.

As an embodiment of a UE operation after measurement/evaluation when the WUR of the UE performs LR RRM measurement/evaluation, if the WUR determines that the serving cell does not the cell selection determination criteria S applied to the WUR during Nₛₑᵣᵥ consecutive DRX cycles (or N_{serv_WUR} consecutive DRX cycles for the WUR defined in the standard or received for the WUR from the system information), the WUR of the UE may trigger on the MR and the WUR may be deactivated. Thereafter, the MR of the UE may directly transmit/receive data from the base station. The MR or the UE may initiate measurement of all neighbor cells other than the serving cell. Further, if the MR or the UE does not find a new suitable cell for 10s, the UE may initiate a cell selection procedure for the selected public land mobile network (PLMN).

Alternatively, when the WUR is activated on to detect a WUS while the MR is in an off state, MR RRM measurement/evaluation may be performed in a K*M1*N1*DRX cycle of a period longer than the M1*N1*DRX cycle when MR RRM measurement/evaluation should be performed. K may be received by the UE through the higher signal for wake-up reception configuration.

Alternatively, when the WUR is activated on to detect a WUS while the MR is in an off state, the MR may be triggered on to perform MR RRM measurement/evaluation only when the WUR of the UE determines that a specific condition is met regardless of the DRX cycle when MR RRM measurement/evaluation should be performed. When the specific condition is not met, the MR RRM measurement/evaluation may not be performed. In other words, the MR is not triggered on to perform MR RRM measurement/evaluation.

The specific condition may be when the cell selection determination criteria described in the disclosure for the WUR in LR RRM measurement/evaluation are not met even once in a context where the WUR is on or the MR is off for a period set by the higher signal or defined in the standard or without period limitations.

The specific condition may be when Sᵣₓₗₑᵥ or S_{qual} in the cell selection determination criteria described in the disclosure for the WUR in LR RRM measurement/evaluation does not meet, even once, criteria determined by one or more thresholds in a context where the WUR is on or the MR is off for a period set by the higher signal or system information or defined in the standard or without period limitations.

For example, it may be when it is less than S_{thresholdP} or S_{thresholdQ}, set by the higher signal or system information. When it is greater than S_{thresholdP} or S_{thresholdQ}, the UE may not perform MR RRM measurement/evaluation. In other words, the MR is not triggered on to perform MR RRM measurement/evaluation.

As another example, it may be when Sᵣₓₗₑᵥ is between S_{thresholdP1} and S_{thresholdP2}, or S_{qual} is between S_{thresholdQ1} and S_{thresholdQ2} based on S_{thresholdP1}, S_{thresholdP2} (S_{thresholdP1}<S_{thresholdP2}) or S_{thresholdQ1}, S_{thresholdQ2} (S_{thresholdQ1}<S_{thresholdQ2}). When Sᵣₓₗₑᵥ is less than S_{thresholdP1}, or when S_{qual} is less than S_{thresholdQ1}, the WUR of the UE may immediately trigger on the MR, and the WUR may be deactivated. When Sᵣₓₗₑᵥ is greater than S_{thresholdP1}, or S_{qual} is greater than S_{thresholdQ1}, the UE may not perform MR RRM measurement/evaluation. In other words, the MR is not triggered on to perform MR RRM measurement/evaluation.

The specific condition may be when, regardless of the LR RRM measurement/evaluation, the LR measures the reception level or quality of signal based on the SS/PBCH or WUS or sync signal dedicated for the WUR, and the reception level or quality of the measured signal does not meet, even once, criteria determined by one or more thresholds set as system information or higher signal or defined in the standard in a context where the WUR is on or the MR is off during a period set by the higher signal or system information or without period limitations. For example, it may be when the reception level or quality of signal is less than S_{thresholdP} Or S_{thresholdQ}. When the reception level or quality of signal is greater than S_{thresholdP} Or S_{thresholdQ}, the UE may not perform MR RRM measurement/evaluation. In other words, the MR is not triggered on to perform MR RRM measurement/evaluation.

As another example, it may be when the signal reception level is between S_{thresholdP1} and S_{thresholdP2}, or signal quality is between S_{thresholdQ1} and S_{thresholdQ2} based on the threshold S_{thresholdP1}, S_{thresholdP2} (S_{thresholdP1}<S_{thresholdP2}) or S_{thresholdQ1}, S_{thresholdQ2} (S_{thresholdQ1}<S_{thresholdQ2}). When the signal reception level is less than S_{thresholdP1}, or when signal quality is S_{thresholdQ1}, the WUR of the UE may immediately trigger on the MR, and the WUR may be deactivated. When signal reception level is greater than S_{thresholdP1}, or when signal quality is greater than S_{thresholdQ1}, the UE may not perform MR RRM measurement/evaluation. In other words, the MR is not triggered on to perform MR RRM measurement/evaluation.

When the WUR is activated on to detect a WUS, and the MR is off, if a WUS is received so that the MR is triggered on, MR RRM measurement/evaluation may be initiated regardless of the DRX cycle when MR RRM measurement/evaluation should be performed. In this case, while the MR is on, MR RRM measurement/evaluation may be performed. The cycle for MR RRM measurement/evaluation may be every M1*N1 DRX cycle like in the conventional MR RRM measurement/evaluation and, to be applicable in this case, a cycle value or new M1 and N1 may be set through a higher signal including WUS reception configuration, or the cycle value or M1 and N1 may be newly defined in the standard. In determining the SS-RSRP measured in the MR RRM measurement/evaluation, the UE may determine the SS-RSRP of the serving cell by filtering from at least L measurement values separated by at least the DRX cycle/L. In determining the measured SS-RSRQ, the UE may determine the SS-RSRQ of the serving cell by filtering from at least L measurement values separated by at least the DRX cycle/L. L may be an integer greater than 2.

The following is a scheme of performing measurement of neighbor cells by a WUR when a WUR is configured and activated.

In order for the WUR of the UE to measure the signal from neighbor cells, the base station may indicate which neighbor cells support or transmit a WUS or a WUR-dedicated sync signal through a higher signal. Or, the base station may indicate, through a higher signal, neighbor cell information (frequency or cell ID) about which neighbor cells a UE having a WUR may measure through the WUR. The UE having the WUR may perform neighbor cell measurement using the WUR through information reception by the higher signal.

When the UE having the WUR performs LR RRM measurement/evaluation described above, if determining that the serving cell does not meet the cell selection determination criteria S proposed for LR during N_{serv_WUR_2} consecutive DRX cycles, the UE may initiate measurement of all neighbor cells other than the serving cell. N_{serv_WUR_2} may be defined in the standard or may be set by a higher signal for the WUR. After initiating measurement of all neighbor cells other than the serving cell, the WUR of the UE may perform measurement of the neighbor cells using the WUR.

As an embodiment of determining the cell reselection determination criteria and measuring neighbor cells using the WUR, a separate set from the parameters required when evaluating neighbor cell measurement/cell reselection evaluation using the MR may be defined to perform neighbor cell measurement/cell reselection evaluation using the WUR. For example, in the cell reselection determination criteria, that cell rankings may be determined in the order of the highest values of Rₛ as defined in Equation (9) below and Rₙ as defined in Equation (10) below is the same as neighbor cell measurement/cell reselection evaluation of the MR, but the following parameters in the equation for determining Rₛ and Rₙ may be for the WUR and be separately defined in the standard or received by the UE by system information or a higher signal during configuration for WUS reception.

$${R}_{s} = {Q}_{meas , s} + {Q}_{hyst} - {Qoffset}_{temp} \qquad ( 9 )$$

$${R}_{n} = {Q}_{meas , n} - Qoffset - {Qoffset}_{temp} \qquad ( 10 )$$

When the WUR of the UE performs neighbor cell measurement/cell reselection evaluation, a new parameter for the WUR may be added to the cell reselection determination criteria as another embodiment for determining the cell reselection determination criteria. For example, the cell reselection determination criteria may be applied only when added as a new parameter (Q_{LP_SS_2} or Q_{WUR}) in Equations (9) and (10) for determining Rₛ and Rₙ so that the addition is explicitly shown in Equations (9) and (10) or added to the existing parameter (Qoffset or Qoffsetₜₑₘₚ) to perform cell reselection determination using the WUR even when not directly shown in the Equations, although determining the cell rankings in order of the highest value of Rₛ and Rₙ is the same as that in the neighbor cell measurement/cell reselection evaluation of the MR. The new parameter may be a value Q_{LP_SS_2} for compensating for the difference in reception magnitude or reception quality between the WUR dedicated sync signal of neighbor cells and the SS/PBCH block or may be a value Q_{WUR} for compensating for the difference in sensitivity between the hardware of the WUR and the hardware of the MR. These values may be defined separately in the standard or may be received by the UE as system information when setting up to receive a WUS.

When the WUR of the UE performs neighbor cell measurement/cell reselection evaluation, as another embodiment, the WUR may be defined separately for the WUR or by a higher signal unlike the time or timer such as the period for neighbor cell measurement or cell reselection determination evaluation period is for the MR. As an example, the time or timer such as Tₘₑₐₛᵤᵣₑ, Tₑᵥₐₗᵤₐₜₑ, T detect, T_{reselection} or the like may be determined for the WUR.

When cell reselection determination evaluation is performed by the WUR so that a new cell is determined as a serving cell, the WUR of the UE may immediately trigger on the MR, and the WUR may be deactivated. Thereafter, the MR of the UE may directly transmit/receive data such as sync reception and system information from the base station. After a predetermined time, the WUR of the UE may be turned on to monitor a WUS again, and the MR may be turned off. The predetermined time may be transmitted by the base station through a higher signal or may be determined in the standard.

When the WUR is configured and activated, LR RRM measurement/evaluation is performed by the WUR. However, a scheme of performing measurement/evaluation of neighbor cells by the MR is described.

When the UE having the WUR performs LR RRM measurement/evaluation described above, if determining that the serving cell does not meet the cell selection determination criteria S proposed for LR during N_{serv_WUR_3} consecutive DRX cycles, the UE may initiate measurement of all neighbor cells other than the serving cell through the MR. N_{serv_WUR_3} may be defined in the standard or may be set by a higher signal for the WUR. When initiating measurement of all neighbor cells other than the serving cell, the UE may turn on the MR even when it fails to receive a WUS and may perform measurement of neighbor cells using the MR.

As an embodiment of performing measurement/evaluation of the serving cell using the WUR and performing measurement and cell reselection determination of neighbor cells using the MR, it may be defined to add an offset to the serving cell measurement value using the WUR for comparing the serving cell measurement value using the WUR and the neighbor cell measurement value using the MR. For example, the cell reselection determination criteria may be applied only when added as a new parameter (Q_{LP_SS_3} or Q_{WUR_3}) for the WUR in Equation (9) for determining Rₛ for ranking the serving cell so that the addition is explicitly shown in the equation or added to the existing parameter (Q_{hyst} or Qoffsetₜₑₘₚ) to perform LR RRM using the WUR even when not directly shown in the Equation, although determining the cell rankings in order of the highest value of Rₛ and Rₙ is the same as that in the existing neighbor cell measurement/cell reselection evaluation to perform cell reselection determination when measuring the neighbor cell using the MR. The new parameter may be a value Q_{LP_SS_3} for compensating for the difference in reception magnitude or reception quality between the WUR dedicated sync signal in the serving cell and the SS/PBCH block in the neighbor cell or may be a value Q_{WUR_3} for compensating for the difference in sensitivity between the hardware of the WUR and the hardware of the MR. These values may be defined separately in the standard or may be received by the UE as system information when setting up to receive a WUS.

In the above case, the time or timer such as the period for neighbor cell measurement or cell reselection determination evaluation period may be separately defined or set by a higher signal as an alternative. For example, the time or timer such as Tₘₑₐₛᵤᵣₑ, Tₑᵥₐₗᵤₐₜₑ, T_{detect}, T_{reselection} or the like may be determined for the above case.

In the above case, when cell reselection determination evaluation is performed so that a new cell is determined as a serving cell, the WUR of the UE may immediately trigger on the MR, and the WUR may be deactivated. Thereafter, the MR of the UE may directly transmit/receive data such as sync reception and system information from the base station. After a predetermined time, the WUR of the UE may be turned on to monitor a WUS again, and the MR may be turned off. The predetermined time may be transmitted by the base station through a higher signal or may be determined in the standard.

Alternatively, the UE having the WUR, when the WUR is configured and activated, may stop neighbor cell measurement or may perform neighbor cell measurement by a longer period than Tₘₑₐₛᵤᵣₑ.

Alternatively, the UE having the WUR, when the WUR is configured and activated, may stop neighbor cell measurement or perform neighbor cell measurement by a longer period than Tₘₑₐₛᵤᵣₑ if measurement by the WUR or measurement based on LR RRM is greater than a specific value set by the base station. The measurement by the WUR may be a WUS detection rate or may be a metric such as RSRP, RSSI, or RSRQ of measuring a wake-up sync signal. The specific value may be received by the UE through a higher signal transmitted by the base station.

Hereinafter, a procedure for waking up a MR when the MR is in the sleep state is described. MR

When there is a channel or signal to be transmitted to the UE, the base station may transmit a WUS to the UE. The UE or the WUR may receive a WUS to turn on the MR. The operation of receiving the WUS itself may be an instruction to wake up the MR. The WUS may include K information bits, and information to wake up the MR may be mapped to the K information bits. For example, when the information bit included in the WUS is 1 bit of information, ‘1’ may indicate ON and ‘0’ may indicate OFF.

In base station transmission, when to transmit a WUS before transmitting a channel or a signal may be predefined. From the UE reception point of view, at which time point to receive the WUS before the channel or signal is received may be predefined.

The UE may transmit, to the base station, information about the time offset required between transmission of the WUS and transmission of the channel/signal, and the base station may configure, to the UE, the time offset between transmission of the WUS and transmission of the channel/signal, based on the received information. The UE may transmit information about the time offset required between transmission of the WUS and transmission of the channel/signal to the base station through the UE capability information reporting procedure, or may transmit the information to the base station through the RA preamble or the UL data channel in the RA procedure. Alternatively, the UE may transmit the information about the time offset to the base station through the higher signal or may transmit the information through various signals. The base station may configure the information about the time offset between the WUS and the transmission of the channel/signal to the UE through the DL data channel of the RA response (e.g., message 2) or the RA competition release (e.g., message 4) in the RA procedure. The base station may configure the information about the time offset to the UE by the higher signal or through various signals.

When the base station has a periodic channel or a periodic signal to be transmitted to the UE, instead of transmitting a WUS whenever the base station has a channel or a signal to be transmitted, the UE or the WUR may turn on the MR according to a periodic channel set from the base station or a period according to configuration information about the periodic signal.

The base station may transmit the WUS only when the periodic channel or the periodic signal is first transmitted, and may omit transmission of the WUS when the channel or the signal is repeatedly transmitted thereafter. In this case, the UE or the WUR may turn on the MR based on the periodic channel set by the base station or the period according to the configuration information about the periodic signal.

The periodic channel or the type of the periodic signal transmitted/received by the base station and the UE may be predefined. The periodic channel or the type of the periodic signal may be set by the base station. The base station may configure the periodic channel or the type of the periodic signal to the UE through a RA response (e.g., message 2) or a DL data channel of RA competition release (e.g., message 4), or may configure the UE through the higher signal or another higher signal indicating configuration information for receiving a WUS.

When the UE has a channel or signal (e.g., the physical RA channel (PRACH), the scheduling request (SR), or the buffer status report (BSR)) to be transmitted to the base station, or when the UE performs the L1/L3-based measurement, the UE or the WUR may turn on the MR regardless of the WUS transmitted by the base station.

The WUR may not apply an operation of receiving the WUS and turning on and off the MR of the UE for UL transmission or layer 1 (L1)/layer 3 (L3)-based measurement transmitted by the UE to the base station.

The type of the UL channel or UL signal of the UE transmitted irrespective of the operation of receiving the WUS or the measurement based on L1/L3 may be predefined. The type of the UL channel or the type of the UL signal or the measurement based on L1/L3 may be configured by the base station. The base station may configure an UL channel or an UL signal type or an L1/L3-based measurement to the UE through a RA response (e.g., message 2) or RA competitive release (e.g., message 4) DL data channel, or may configure the UE through the higher signal or another higher signal indicating configuration information for receiving a WUS.

An operation of turning off the MR when the MR is in an on state is now described. When the MR is in an on state, the operation of waking up the MR may be performed in combination with or separately from various operations according to various embodiments.

When there is a channel or signal to be transmitted to the UE, the base station may transmit a sleep signal to the UE. The UE or the WUR may receive the sleep signal to turn off the MR. The operation of receiving the sleep signal itself may be an instruction to put the MR to sleep. The sleep signal may be configured as a sequence separate from the WUS. The sleep signal may include information mapped to information indicating that the MR is to be put to sleep in K information bits included in the WUS. For example, when the information is 1-bit information, ‘0’ may indicate OFF and ‘l’ may indicate ON.

The MR of the UE may be turned off when a set condition is met. The condition set for the MR may be when the MR fails to detect or decode a downward control channel, a specific channel, or a signal during a set period. The base station may configure configuration information (e.g., information including a period and a specific channel or signal) for the UE to determine to turn off the MR to the UE through the higher signal indicating configuration information for receiving the WUS and/or another higher signal.

The MR of the UE may always be turned off after receiving one channel or signal. According to an embodiment, after the WUR receives the WUS from the base station and the MR is turned on to receive a channel or signal, the MR may be turned off. The time required for the MR to be turned off after the channel or reception is completed may be predefined. The UE may transmit information about a time required until the MR is turned off to the base station, and the base station may set the required time to the UE based on the received information. The information about the required time transmitted by the UE may be transmitted to the base station through the UE capability information reporting procedure. The information about the required time transmitted by the UE may be transmitted to the base station through a RA preamble or an UL data channel. Of course, the disclosure is not limited thereto, and the UE may transmit information about the required time to the base station through the higher signal. The base station may configure information about the required time to be transmitted to the UE to the UE through a DL data channel of a RA response (e.g., message 2) or RA competition release (e.g., message 4). Of course, the disclosure is not limited thereto, and the base station may configure the information about the required time to the UE by the higher signal.

When the UE or the MR of the UE is in the RRC_CONNECTED state, the UE may perform PDCCH reception when the MR wakes up every DRX cycle as a connected mode DRX (C-DRX) is set. When the UE or the MR of the UE is in the RRC_CONNECTED state, the UE (or the MR) may be configured to receive a signal indicating whether the UE should receive a PDCCH in the next DRX cycle.

When the MR is in the RRC_IDLE/RRC_INACTIVE state, the UE may receive a paging PDCCH as an idle mode DRX (I-DRX) is set and the MR wakes up every paging cycle. When the UE or the MR of the UE is in the RRC_CONNECTED state, the UE (or the MR) may be configured to receive a signal indicating to the UE whether to receive a paging PDCCH in the next paging cycle.

The following is a procedure of a UE operating as a WUR when an operation of indicating ON/OFF based on reception of a WUS of a WUR and a MR and an operation according to configuration of C-DRX or I-DRX are mixed. The operation of the UE or the MR of the UE related to the RRC_CONNECTED/IDLE/INACTIVE state may be performed in combination with or separately from various operations according to various embodiments, and may not be an essential component.

When the UE having the WUR receives the WUS and performs an operation of turning on and off the MR of the UE, the UE may not perform an operation of setting a C-DRX or the I-DRX or an operation according to the setting. In this case, instead of performing the operation of setting the C-DRX or I-DRX and operations according to the setting, the UE may turn on the MR of the UE only when receiving a WUS to wake up the MR, and may receive a PDCCH and a PDSCH defined or set to be received in the C-DRX or I-DRX, respectively.

When the UE or the MR of the UE is in the RRC_CONNECTED state and an operation performed by the WUR is configured or activated by the base station, the UE may turn on the MR when the WUR receives a WUS to wake up the MR, and may also perform an operation related to the set C-DRX from the base station (e.g., the MR receives a PDCCH within drx_onDurationTimer every DRX cycle). The UE (or MR) may not perform an operation configured to receive a signal (e.g., DCI format 2_6) indicating to the UE whether to receive a PDCCH in the next DRX cycle. When the UE or the MR of the UE is in the RRC_IDLE/INACTIVE state and an operation performed by the WUR is configured or activated by the base station, the UE may turn on the MR when the WUR receives a WUS to wake up the MR, and may also perform an operation related to the I-DRX set by the base station (e.g., the MR wakes up every paging cycle to receive a paging PDCCH). The UE (or MR) may not perform an operation configured to receive a signal (e.g., DCI format 2_7) indicating to the UE whether to receive a paging PDCCH in the next paging cycle.

The UE may perform an operation for waking up the WUR and the MR according to the WUS and an operation for turning off the MR according to the WUS according to various embodiments, instead of an operation according to a configuration related to C-DRX or I-DRX. If the operation performed by the WUR is deactivated by the base station, the operations related to the C-DRX or the I-DRX configured by the base station may be performed again.

When the operation performed by the WUR of the UE is configured or activated by the base station, and the UE or the WUR receives the WUS and the MR is turned on, the UE may be switched to the RRC_CONNECTED state or to the RRC_IDLE or RRC_INACTIVE state. It may be determined to which state the UE may be switched, in advance, or by the higher signal or a separate higher signal the WUR operation configuration from the base station.

As an example where the information about the UE transition is predetermined, the state of the MR may follow a state immediately before the MR is turned on and off most recently just before the current turn-on time. According to an embodiment, as another example where the information about the UE's switching is predetermined, the state of the MR may not be affected by whether to configure and activate the WUR operation. For example, the state of the MR of the UE may be determined only by the higher signal indicating at least one of RRC_CONNECTED, RRC_IDLE, or RRC_INACTIVE, and the UE may determine that the state of the MR is not switched by whether to configure and activate the WUR operation.

The WUS may include K information bits, and information about at least one of whether the MR goes to the RRC_CONNECTED state, the RRC_IDLE state, or the RRC_INACTIVE state may be mapped to the K information bits.

When the UE or the MR of the UE is in the RRC_CONNECTED state based on the determined state of the UE, the MR may wake up and receive a PDCCH every DRX cycle by the C-DRX configured by the base station, or the UE (or the MR) may be configured to receive a signal indicating to the user whether the PDCCH should be received in the next DRX cycle from the base station. When an operation for turning off the MR according to various embodiments is performed while the UE receives a PDCCH (e.g., a PDCCH reception interval), the UE may first perform a procedure for turning off the MR.

When the UE or the MR of the UE is in the RRC_IDLE/INACTIVE state, the MR may wake up and receive the paging PDCCH every paging cycle by the I-DRX configured by the base station. The UE (or MR) may be configured to receive a signal indicating whether to receive a paging PDCCH in the next paging cycle from the base station. When an operation for turning off the MR according to various embodiments is performed while the UE receives a paging PDCCH (e.g., a paging PDCCH reception interval), the UE may first perform a procedure for turning off the MR.

The various operations of the UE (or MRs) described above may be performed regardless of the order, and the entity performing the operations may be either or both the UE or/and the MR.

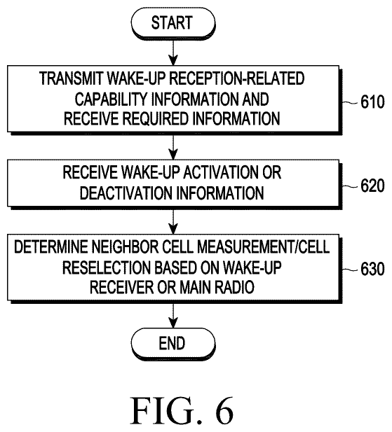

FIG. 6 illustrates a method of RRM measurement of a UE having a WUR according to an embodiment.

In step 610, the UE may transmit wake-up reception-related capability information to the base station and receive information required for WUS reception from the base station. The UE including the WUR may report to the base station that the UE has the capability to wake up the MR using the WUR or may report to the base station capability information indicating that the UE includes the WUR. The base station may transmit, to the UE, a signal indicating whether to use the WUR or configuration information for receiving the WUS.

In step 620, the UE may receive a wake-up activation signal from the base station to receive a WUS using the WUR, or may receive a wake-up deactivation signal from the base station to no longer receive a WUS using the WUR. The base station may transmit, to the UE, a signal indicating whether to use the WUR or configuration information for receiving the WUS. Accordingly, the UE including the WUR among the UEs receiving the signal from the base station may turn on/off the MR through the WUR. The UE may receive a WUS or a WUR-dedicated sync signal to determine whether to activate/deactivate the WUR.

In step 630, the UE may perform measurement and cell reselection determination on a neighbor cell in the WUR or MR. In an embodiment, in a state in which the WUR is on to be configured or activated to be able to discover a WUS, and the MR is off, the WUR of the UE (or a UE having a WUR) may perform neighbor cell measurement/cell reselection determination instead of the neighbor cell measurement/cell reselection determination that should be performed by the MR of the UE.

The UE may transmit WUS reception-related UE capability information to the base station. The UE may receive the WUS reception-related information from the base station. The UE may determine whether to initiate measurement on at least one neighbor cell in the WUR for a first period based on the WUS reception-related information. The UE may perform measurement on at least one neighbor cell by the WUR based on the WUS reception-related information.

The MR for cell measurement of the UE may be inactive, and the WUR may be active. The WUS reception-related information may include indication information about at least one neighbor cell supporting a WUS. Determining whether to initiate measurement on at least one neighbor cell in the WUS during the first period may be based on a first parameter for serving cell measurement of the WUS, and the first parameter may be preset or be included in the WUS reception-related information.

The first parameter may be related to a difference between the signals received by the WUR and the MR of the UE. In an embodiment, it may differ from a second period that is preset or included in the WUS reception-related information to determine neighbor cell measurement initiation in the MR of the UE.

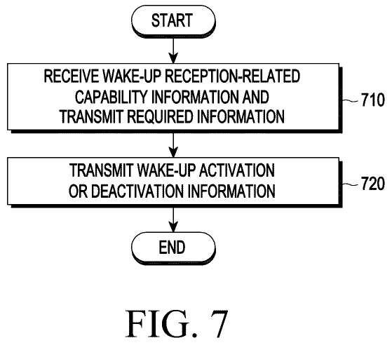

FIG. 7 illustrates a method of a base station to transmit a signal for measuring an RRM according to an embodiment.

Referring to FIG. 7, in step 710, the base station may receive wake-up reception-related capability information from the UE and transmit information required for WUS reception to the UE according to an embodiment. The UE including the WUR may report to the base station that the UE has the capability to wake up the MR using the WUR or may report to the base station capability information indicating that the UE includes the WUR. The base station may transmit, to the UE, a signal indicating whether to use the WUR or configuration information for receiving the WUS.

In step 720, the base station may transmit a wake-up activation signal to receive a WUS using the WUR or transmit a wake-up deactivation signal to the UE not to receive a WUS any longer using the WUR according to an embodiment, based on determination of whether to authorize use of the WUR of the UE. The base station may transmit, to the UE, a signal indicating whether to use the WUR or configuration information for receiving the WUS. Accordingly, the UE including the WUR among the UEs receiving the signal from the base station may turn on/off the MR through the WUR. The base station may transmit the WUR-dedicated sync signal required for the UE to perform RRM measurement or SS/PBCH or WUS to the UE. The base station may receive WUS reception-related UE capability information from the UE. The base station may transmit the WUS reception-related information to the UE. The WUS reception-related information may be used to determine whether to initiate measurement on at least one neighbor cell for a first period in the WUR of the UE and to perform measurement on at least one neighbor cell.

The MR for cell measurement of the UE may be inactive, and the WUR may be active. The WUS reception-related information may include indication information about at least one neighbor cell supporting a WUS. The WUS reception-related information may include a first parameter for serving cell measurement of the WUR. The first parameter may be used to determine whether to initiate measurement on the at least one neighbor cell in the WUR during the first period and may be related to a difference between the signals received by the WUR and the MR of the UE.

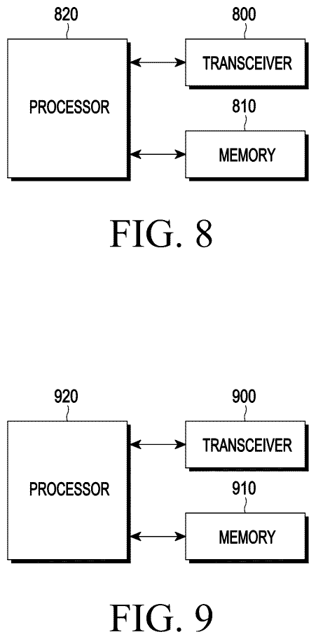

FIG. 8 illustrates a functional structure of a UE according to an embodiment.

According to an embodiment, a UE may include a processor 820 controlling the overall operation of the UE, a transceiver 800 including a transmitter and a receiver, and memory 810. Without limited thereto, the UE may include more or fewer components than those shown in FIG. 8.

The transceiver 800 may transmit/receive signals to/from network entities or each network node including the base station. The signals transmitted/received with the network entity may include control information and data. The transceiver 800 may receive signals via a radio channel, output the signals to the processor 820, and transmit signals output from the processor 820 via a radio channel.

The processor 820 included in the UE according to an embodiment may control to transmit WUS reception-related UE capability information to the base station. The processor 820 may control to receive the WUS reception-related information from the base station. The processor 820 may determine whether to initiate measurement on at least one neighbor cell in the WUR for a first period based on the WUS reception-related information. The processor 820 may perform measurement on at least one neighbor cell by the WUR based on the WUS reception-related information.

The MR for cell measurement of the UE may be inactive, and the WUR may be active. The WUS reception-related information may include indication information about at least one neighbor cell supporting a WUS. In an embodiment, determining whether to initiate measurement on at least one neighbor cell in the WUS during the first period may be based on a first parameter for serving cell measurement of the WUS, and the first parameter may be preset or be included in the WUS reception-related information.

The first parameter may be related to a difference between the signals received by the WUR and the MR of the UE. In an embodiment, it may differ from a second period that is preset or included in the WUS reception-related information to determine neighbor cell measurement initiation in the MR of the UE.

FIG. 9 illustrates a functional structure of a base station according to an embodiment.

A base station may include a processor 920 controlling the overall operation of the base station, a transceiver 900 including a transmitter and a receiver, and memory 910. Without limitations thereto, the base station may include more or fewer components than those shown in FIG. 9.

The transceiver 900 may transmit/receive signals to/from other network nodes such as network entities or the UE. The signals transmitted/received with the network entity may include control information and data. The transceiver 900 may receive signals via a radio channel, output the signals to the processor 920, and transmit signals output from the processor 920 via a radio channel.

The processor 920 according to an embodiment may control to receive WUS reception-related UE capability information from the UE. The processor 920 may control to transmit the WUS reception-related information to the UE. The WUS reception-related information may be used to determine whether to initiate measurement on at least one neighbor cell for a first period in the WUR of the UE and to perform measurement on at least one neighbor cell.

The MR for cell measurement of the UE may be inactive, and the WUR may be active. The WUS reception-related information may include indication information about at least one neighbor cell supporting a WUS. The WUS reception-related information may include a first parameter for serving cell measurement of the WUR. The first parameter may be used to determine whether to initiate measurement on the at least one neighbor cell in the WUR during the first period and may be related to a difference between the signals received by the WUR and the MR of the UE.

The methods according to the embodiments described in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the disclosure.

The programs (software modules or software) may be stored in RA memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

Herein, the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term unit means a software element or a hardware element such as a field-programmable gate array (FPGA) or an application specific integrated circuit (ASIC). A unit plays a certain role. However, unit is not limited to software or hardware. A unit may be configured in a storage medium that may be addressed or may be configured to execute one or more processors. Accordingly, as an example, a unit includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the units may be combined into smaller numbers of components and units or further separated into additional components and units. The components and units may be implemented to execute one or more CPUs in a device or secure multimedia card. According to embodiments, a . . . unit may include one or more processors.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a user equipment (UE) in a wireless communication system, the method comprising:
transmitting, to a base station, wake-up signal reception-related UE capability information;
receiving, from the base station, wake-up signal reception-related information; and
performing measurement on at least one neighbor cell by one of a wake-up receiver of the UE and a main radio of the UE based on the wake-up signal reception-related information.

2. The method of claim 1, further comprising:
performing cell reselection by comparing a first value of cell measurement on a serving cell using the wake-up receiver with a second value of cell measurement on the at least one neighbor cell using the wake-up receiver considering an offset value of the first value.

3. The method of claim 1,
wherein the wake-up signal reception-related information includes indication information about the at least one neighbor cell supporting a wake-up signal.

4. The method of claim 1, further comprising:
determining whether to initiate the measurement on the at least one neighbor cell by the wake-up receiver for a first period is based on a first parameter for serving cell measurement of the wake-up receiver, and
wherein the first parameter is predefined or is included in the wake-up signal reception-related information.

5. The method of claim 4,
wherein the first parameter is related to a difference between signals received by the wake-up receiver and the main radio of the UE.

6. The method of claim 4,
wherein the first period is predefined or is included in the wake-up signal reception-related information, and
wherein the first period differs from a second period for determining whether to initiate neighbor cell measurement in the main radio of the UE.

7. A method performed by a base station in a wireless communication system, the method comprising:
receiving, from a UE, wake-up signal reception-related UE capability information; and
transmitting, to the UE, wake-up signal reception-related information,
wherein the wake-up signal reception-related information is used to perform measurement on at least one neighbor cell by one of a wake-up receiver of the UE and a main radio of the UE.

8. The method of claim 7,
wherein the wake-up signal reception-related information is used to determine whether to initiate measurement on the at least one neighbor cell by one of the wake-up receiver of the UE and the main radio of the UE.

9. The method of claim 7,
wherein the wake-up signal reception-related information includes indication information about the at least one neighbor cell supporting a wake-up signal.

10. The method of claim 7,
wherein the wake-up signal reception-related information includes a first parameter for serving cell measurement of the wake-up receiver, and
wherein the first parameter is used to determine whether to initiate measurement on the at least one neighbor cell in the wake-up receiver for a first period and is related to a difference between signals received by the wake-up receiver and the main radio of the UE.

11. A user equipment (UE) in a wireless communication system, the UE comprising:
a transceiver; and
at least one processor configured to:
transmit, to a base station, wake-up signal reception-related UE capability information,
receive, from the base station, wake-up signal reception-related information, and
perform measurement on at least one neighbor cell by one of a wake-up receiver of the UE and a main radio of the UE based on the wake-up signal reception-related information.

12. The UE of claim 11, wherein the at least one processor is further configured to:
perform cell reselection by comparing a first value of cell measurement on a serving cell using the wake-up receiver with a second value of cell measurement on the at least one neighbor cell using the wake-up receiver considering an offset value of the first value.

13. The UE of claim 11,
wherein the wake-up signal reception-related information includes indication information about the at least one neighbor cell supporting a wake-up signal.

14. The UE of claim 11, wherein the at least one processor is further configured to:
determine whether to initiate the measurement on the at least one neighbor cell by the wake-up receiver for a first period is based on a first parameter for serving cell measurement of the wake-up receiver, and
wherein the first parameter is predefined or is included in the wake-up signal reception-related information.

15. The UE of claim 14,
wherein the first parameter is related to a difference between signals received by the wake-up receiver and the main radio of the UE.

16. The UE of claim 14,
wherein the first period is predefined or is included in the wake-up signal reception-related information, and
wherein the first period differs from a second period for determining whether to initiate neighbor cell measurement in the main radio of the UE.

17. A base station in a wireless communication system, the base station comprising:
a transceiver; and
at least one processor configured to:
receive, from a UE, wake-up signal reception-related UE capability information, and
transmit, to the UE, wake-up signal reception-related information,
wherein the wake-up signal reception-related information is used to perform measurement on at least one neighbor cell by one of a wake-up receiver of the UE and a main radio of the UE.

18. The base station of claim 17,
wherein the wake-up signal reception-related information is used to determine whether to initiate measurement on the at least one neighbor cell by one of the wake-up receiver of the UE and the main radio of the UE.

19. The base station of claim 17,
wherein the wake-up signal reception-related information includes indication information about the at least one neighbor cell supporting a wake-up signal.

20. The base station of claim 17,
wherein the wake-up signal reception-related information includes a first parameter for serving cell measurement of the wake-up receiver, and
wherein the first parameter is used to determine whether to initiate measurement on the at least one neighbor cell in the wake-up receiver for a first period and is related to a difference between signals received by the wake-up receiver and the main radio of the UE.
